(19) United States
(12) Patent Application Publication
(10) Pub. No.: US 2021/0319381 A1
(43) Pub. Date: Oct. 14, 2021

(54) SCHEDULE MEDIATION SYSTEM AND SCHEDULE MEDIATION METHOD

(71) Applicant: HITACHI, LTD., Tokyo (JP)

(72) Inventors: Tomoichi EBATA, Tokyo (JP); Kei SUZUKI, Tokyo (JP); Satoru HORI, Tokyo (JP); Kojin YANO, Tokyo (JP)

(73) Assignee: HITACHI, LTD., Tokyo (JP)

(21) Appl. No.: 17/186,505

(22) Filed: Feb. 26, 2021

(30) Foreign Application Priority Data
Apr. 13, 2020 (JP) 2020-071857

(51) Int. Cl. G06Q 10/06; G06Q 10/08; G06Q 30/06; G06Q 30/02

(52) U.S. Cl. CPC G06Q 10/06312; G06Q 10/087; B60P 3/025; G06Q 30/0633; G06Q 30/0204; G06Q 10/06315

(57) ABSTRACT

Profits of respective stakeholders related to business by mobile shop vehicles are efficiently adjusted, and preferable schedules for the mobile shops can be created. A schedule mediation system includes: an in-vehicle server configured to hold inventory information, receive request information containing various information about merchandise etc. for which a customer asks from a user terminal, create an initial schedule for mobile sales based on a purchase place and a purchase date and time shown by purchase conditions and send it to a mediation server, receive an after-correction schedule corrected according to a mediation result in the server and, in response to this, correct the request information and sends it to the user terminal; and a schedule mediation server configured to perform mediation processing for settling a competing situation between the initial schedules shown by the mediation request, correct the initial schedule, and send an after-correction schedule to the in-vehicle server.

### CROSS-REFERENCE TO RELATED APPLICATION

This application claims priority pursuant to 35 U.S.C. § 119 from Japanese Patent Application No. 2020-071857, filed on Apr. 13, 2020, the entire disclosure of which is incorporated herein by reference.

### BACKGROUND

### Technical Field

The present invention relates to a schedule mediation system and a schedule mediation method.

### Related Art

Discontinuance of business of shops is increasing with the growing number of users of Internet-order sales, and decrease in both the number of shops and the number of buyers at the shops under the effect of decrease in the birthrate. In such an environment, in recent years, the number of mobile shops utilizing movable bodies as shops is increasing.

For example, according to the service shown in The Internet <URL: https://www.mellow.jp/>[retrieved on Dec. 17, 2019], a mobile shop vehicle and an operating space for the mobile shop vehicle are provided to a shopkeeper of the mobile shop. Moreover, to the provider of the operating space, advertisement of the above operating space and a support for managing the place are given. Thus, an owner of the mobile shop can run the business at the shop while suppressing a commencement-of-business cost and personnel expenses, and open the shop in a popular area.

Moreover, according to the service shown in the Internet <URL: https://shop.aeon.com/netsuper/01050000060590/>[retrieved on Dec. 17, 2019], the same day delivery service at the existing supermarket is provided. This service enables the same-day delivery of perishable foods, such as rice and vegetables, besides the miscellaneous daily necessities, underwear, and electric appliances.

Further, a mobile shop system proposed in Japanese Unexamined Patent Application Publication No. 2019-139371 includes; a plurality of mobile shop vehicles and a server device. The server device has: a request acquiring means which acquires a visit request to the mobile shop vehicles from a user using the mobile shop system and which acquires, as the visit request, a shop of choice that the user wishes to visit among shops the mobile shop vehicles have; a positional information acquiring means which acquires positional information about the mobile shop vehicles and the user; an operation schedule creating means which creates operation schedule of the mobile shop vehicles based on the visit request acquired by the visit request acquiring means and the positional information acquired by the positional information acquiring means and which creates the operation schedule such that the user and the mobile shop vehicle equipped with the shop of choice can get together at a predetermined place; and a sending means which sends the operation schedule created by the operation schedule creating means to the mobile shop vehicles. Furthermore, each of the mobile shop vehicles has: a receiving means for receiving the operation schedule sent by the sending means; and an operation managing means which manages the operation of vehicles based on the operation schedule.

The patent publication described above discloses a technique, when many mobile sales vehicles gather at a large parking lot of a shopping mall, for dynamically allowing mobile sales vehicles to be automatically arranged in consideration of the purchase line of flow of the users using the mobile shops.

In the conventional technology described above, the shop hours and operating location of a mobile shop become restrictive, and there is a problem that the matching with a management person and a user of a mobile shop is difficult. Moreover, since the shop hours and the location are governed by the host system, there is also a problem that methods of doing business (example: at which location and when the mobile shop is opened) are uncontrollable for the management person of the mobile shop.

Moreover, although the base in which large allocation-of-vehicle space where mobile shop vehicles can park and operate, and people who become the customers gather will be requisite for the service, such an area is limited to specific facilities.

Moreover, the number of bases to which a mobile shop vehicle can move in a day is one place in principle, and the mobile shop cannot offer services at many locations. Furthermore, if a movement area and time are not mediated precisely in advance, there is also a possibility that what is called “a dispute over territory” may occur.

On the other hand, on the customers' side using the mobile shop vehicle, it is important whether or not a mobile shop vehicle comes to a convenient area and a date and time, and desired merchandise are in stock in the mobile shop.

However, in the conventional technology, mediation of schedules of mobile shop vehicles and meeting these customers' needs are not available. Therefore, for a certain customer, while his/her demand has hardly be fulfilled about a visit etc. of a mobile shop vehicle, only dissatisfaction grows every day, and there have been enough possibilities of coming to cancel the service concerned.

### SUMMARY

In view of the above, an object of the present invention is to provide a technology which can efficiently adjust profits of respective stakeholders related to business by mobile shop vehicles and preferable schedules for the mobile shops can be created.

A schedule mediation system of the present invention solving the above problems includes an in-vehicle server of a mobile sales vehicle having a storage unit configured to hold at least inventory information showing a merchandise stock on board, and an arithmetic unit configured to execute processing of receiving, from a user terminal of a customer, request information containing various information about merchandise and purchase conditions for which a customer asks, checking the inventory of the merchandise based on the inventory information and, based on a purchase place and a purchase date and time shown by the purchase conditions, creating an initial schedule for a mobile sales, processing of sending a mediation request including the initial schedule to a schedule mediation server and receiving, from the server, an after-correction schedule corrected according to a result of mediation between mediation requests in the server, processing of judging acceptance/rejection by a predetermined rule with respect to the after-correction schedule and giving a result of judgment to the server, and processing of correcting the request information according to the after-correction schedule accepted in the judgment and sending the corrected request information to the user terminal. The schedule mediation system of the present invention also includes a schedule mediation server having a storage unit configured to hold the mediation request received from the in-vehicle server of each mobile sales vehicle, and an arithmetic unit configured to execute, between the initial schedules shown by the held mediation request, in response to the competing situation concerning a purchase place and the purchase date and time, processing of mediation to settle the competing situation between the initial schedules and correcting the initial schedule based on a result of the meditation, processing of sending an after-correction schedule acquired in the correction to the in-vehicle server, and processing of receiving a judgment result of acceptance/rejection in the in-vehicle server with respect to the after-correction schedule from the in-vehicle server and, when the judgment result is a rejection, acquiring a newly corrected schedule by another correction to settle the competing situation and re-proposing the new after-correction schedule to the in-vehicle server. Also, according to a schedule mediation method of the present invention, an in-vehicle server of a mobile sales vehicle holds at least inventory information showing merchandise stock on board. Further, in the schedule mediation method of the present invention, the in-vehicle server of the mobile sales vehicle executes processing of receiving, from a user terminal of a customer, request information containing various information about merchandise and purchase conditions for which a customer asks, checking the inventory of the merchandise based on the inventory information and, based on purchase place and a purchase date and time shown by the purchase conditions, creating an initial schedule for a mobile sale, processing of sending a mediation request including the initial schedule to a schedule mediation server and receiving, from the server, an after-correction schedule corrected according to a result of mediation between mediation requests in the server, processing of judging acceptance/rejection according to a predetermined rule with respect to the after-correction schedule and giving a result of the judgment to the server, and processing of correcting the request information according to the after-correction schedule accepted in the judgment and sending the corrected request information to the user terminal. Still further, in the schedule mediation method of the present invention, the schedule mediation server holds the mediation request received from an in-vehicle server of each mobile sales vehicle, and executes processing of mediation to settle a competing situation between initial schedules indicated by the held mediation request according to the competing situation with respect to the purchase place and the purchase date and time, and correcting the initial schedule based on a result of the mediation, processing of sending an after-correction schedule acquired in the correction to the in-vehicle server, and processing of receiving, from the in-vehicle server, a judgment result concerning acceptance/rejection to the after-correction schedule in the in-vehicle server and, when the judgment result is a rejection, acquiring a new after-correction schedule from another correction for settling the competing situation and re-proposing the new after-correction schedule to the in-vehicle server.

According to the present invention, with respect to business by mobile shop vehicle, profits of a provider of an operating place, a shop owner, and customers can be efficiently adjusted and preferable schedules for the mobile shop can be created.

### BRIEF DESCRIPTION OF THE DRAWINGS

FIG. 1 is a diagram showing an example of a configuration of a schedule mediation system;

FIG. 2 is a diagram showing an example of a hardware configuration of a computer according to the present embodiment;

FIG. 3 is a diagram showing an operational image of schedule mediation in the present embodiment;

FIG. 4 is a diagram showing an image of an application field of the schedule mediation according to the present embodiment;

FIG. 5 is a sequence diagram showing a schedule mediation method according to the present embodiment;

FIG. 6A is a diagram showing a screen example according to the present embodiment;

FIG. 6B is a diagram showing a screen example according to the present embodiment;

FIG. 7 is a diagram showing an example of software configuration in a user terminal according to the present embodiment;

FIG. 8 is a diagram showing an example of a software configuration in an in-vehicle server according to the present embodiment;

FIG. 9 is a diagram showing a status of a migration request according to the present embodiment;

FIG. 10 is a diagram showing an example of clustering a migration request based on information about a location (latitude, longitude), and time according to the present embodiment;

FIG. 11 is a diagram showing a creation concept of an initial schedule based on a cluster according to the present embodiment;

FIG. 12 is a diagram showing an example of an initial schedule according to the present embodiment;

FIG. 13 is a diagram showing the initial schedule according to the present embodiment;

FIG. 14 is a diagram showing an example of a message of the initial schedule according to the present embodiment;

FIG. 15 is a diagram showing an example of a software configuration in the ground server according to the present embodiment;

FIG. 16 is a diagram showing a competing situation in the initial schedule of the present embodiment;

FIG. 17 is a diagram showing the competing situation in the initial schedule of the present embodiment;

FIG. 18 is a diagram showing an example of a mobile shop sales schedule avoiding the competing situation according to the present embodiment;

FIG. 19 is a diagram showing the example of a mobile shop sales schedule avoiding the competing situation according to the present embodiment;

FIG. 20 is a diagram showing an example of a counter-proposal message according to the present embodiment; and

FIG. 21 is an ER diagram of the data used by the schedule mediation system according to the present embodiment.

### DETAILED DESCRIPTION OF EMBODIMENTS

### <Network Configuration >

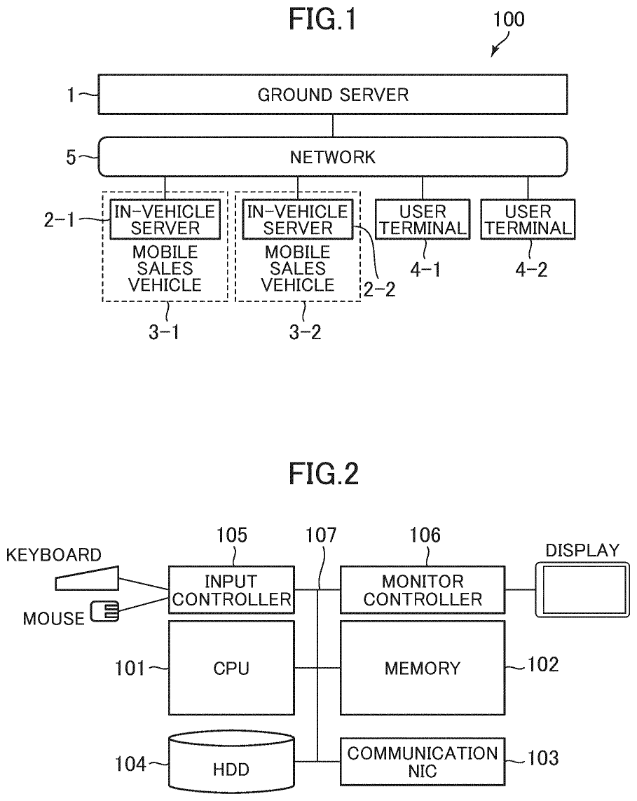

With reference to the drawings, embodiments of the present invention will be explained in detail below. FIG. 1 is a diagram showing the example of a network configuration of the schedule mediation system 100 according to the present embodiment.

In the schedule mediation system 100 of the present embodiment, a ground server 1, an in-vehicle server 2, and a user terminal 4 are communicably connected through an appropriate network 5.

In addition, the in-vehicle server 2 is carried in each of a plurality of mobile sales vehicles 3. Therefore, an example is shown where mobile sales vehicles 3-1 and 3-2 exist as mobile sales vehicles 3, and in-vehicle servers 2-1 and 2-2 exist as the in-vehicle servers 2. However, such number is only an example and not limitative. Similarly, user terminals 4-1 and 4-2 also exist as the user terminals 4.

Moreover, types of the network 5 is not limited and it may be a cellular-phone carrier network, the Internet, a wireless LAN, a cable LAN, etc.

The above in-vehicle server 2 holds its own KPI (Key Performance Indicator: important performance evaluation indicator). This is called a “shop KPI” in the present embodiment. It is an object of the schedule mediation system 100 of the present embodiment to perform schedule mediation to achieve or maximize the shop KPI. Examples include the shop KPI, the number of shop visitors a day, sales amount a day, sales per unit time, etc.

The ground server 1 performs mediation of mobile shop sales schedules of the in-vehicle server 2. In addition, KPI exists also in the ground server 1 and, this is called a “whole KPI” in the present embodiment. It is an object of the ground server 1 to achieve or maximize the whole KPI. Examples of Whole KPI are the sum of business hours a day of the mobile sales vehicle carrying the in-vehicle server 2 and a moving distance, etc.

Thus, one object of the schedule mediation system 100 according to the present embodiment is to maximize the above whole KPI and, at the same time, to maximize the shop KPI of the in-vehicle server 2. Therefore, mediation messages shall be exchanged between the ground server 1 and the in-vehicle server 2, as well as between the in-vehicle server 2 and the user terminal 4. Hereafter, the exchange of the mediation messages is called “mediation.”

### <Hardware Configuration >

Further, a hardware configuration of devices included in the schedule mediation system 100 of the present embodiment will be explained. FIG. 2 is a diagram showing an example of a hardware configuration of a computer, such as the ground server 1, the in-vehicle server 2, and the user terminal 4 which are included in the schedule mediation system 100.

In this case, the computer includes a CPU 101 (arithmetic unit), a memory 102 (storage unit), communication NIC 103 (communication unit), a hard disk drive (hereafter, called “HDD”) 104 (storage unit), the input controller 105, and a monitor controller 106 being connected through a bus 107 etc.

Among these, CPU 101 is an arithmetic unit which reads a program held in the HDD 104 into the memory 102 etc., executes it, and performs a general control of the unit itself. At the same time, it performs various judgments, calculation, and control processing.

Moreover, the memory 102 includes volatile memory elements, such as a RAM.

Further, the communication NIC 103 is a network interface card which connects with a network 5 and performs a communication processing with other units.

Still further, the HDD 104 is a storage means which includes a nonvolatile storage elements, and may be an SSD (Solid State Drive).

Still further, the input controller 105 is connected with input units, such as a keyboard and a mouse, and controls the user input of the data dealt in the computer.

Still further, the monitor controller 106 is connected with display units, such as a display, and the monitor controller 106 controls the output of the data dealt in the computer.

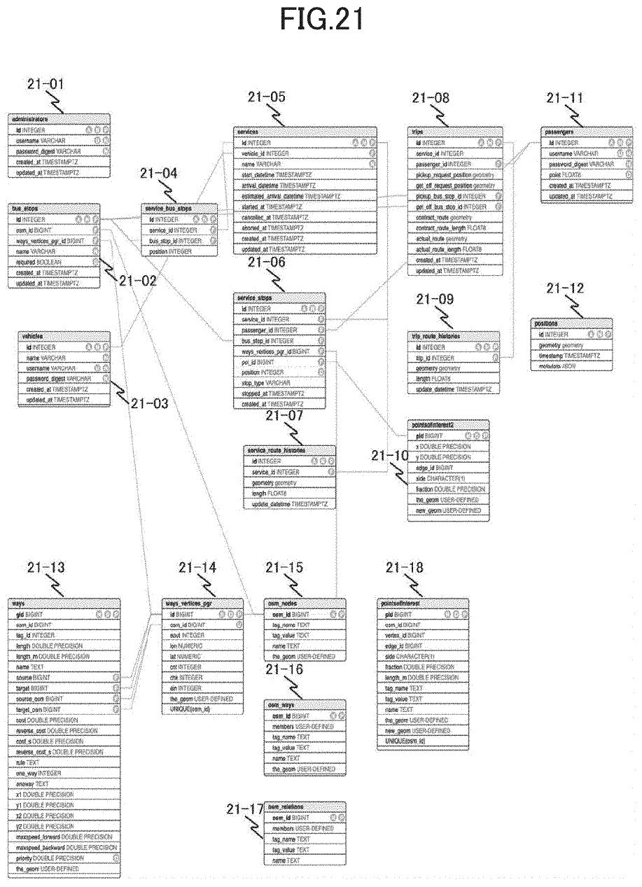

In addition to the program providing a function required for a device included in the schedule mediation system 100 of the present embodiment, at lease a data set for processing (see FIG. 21, for example) is stored on HDD 104.

### <Application Image >

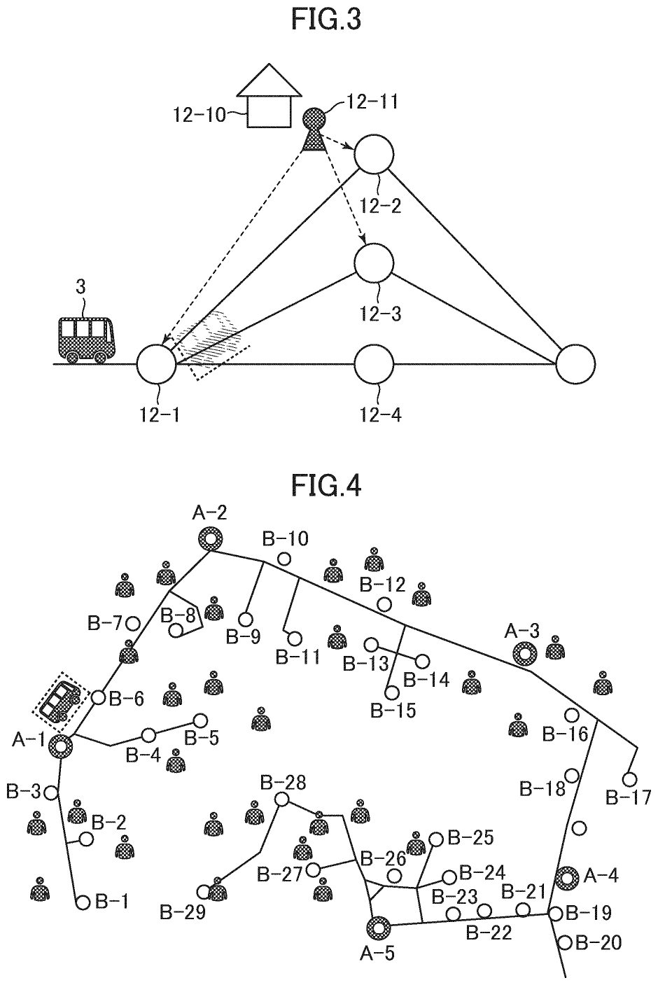

FIG. 3 is a diagram showing the application image of the schedule mediation according to the present embodiment. With respect to the mobile sales vehicle 3, a customer 12-11 who is an owner of the user terminal 4 wishes the mobile sales vehicle 3 to come at a desired date and time and to operate at position 12-2 which is close to his or her residence 12-10 and where the shop can be opened (namely, operating place).

Therefore, the customer 12-11 concerned manipulates the user terminal 4 and, with respect to desired conditions such as the above operating place and the date and time, requests as above to the in-vehicle server 2 of the mobile shop vehicle.

On the other hand, there may be a case where accepting the request of the above customer 12-11 may not be profitable for the mobile sales vehicle 3's operator. For example, there is a case where enough number of customers cannot be expected at position 12-2. Also, when position 12-2 is far from the base, excessive transit time and increased fuel charge are required. Moreover, the mobile sales vehicle 3 may compete with another mobile sales vehicle 3 with respect to the operating date and time (for a customer, a purchase date and time) and an operating place.

On the other hand, for the mobile sales vehicle 3 in this case, not the position 12-2 but the position 12-3 or position 12-4 may be more profitable for its business.

However, if the request from the customers 12-11 are continuously rejected, there is possibility that the customers 12-11 may stop using the mobile sales vehicles 3.

In view of the above, an object of the schedule mediation system 100 of the present embodiment is to preferably maintain the use of the mobile sales vehicle by the customer and business of the mobile sales vehicle by performing well-balanced mediation between requests of the respective customers and business restrictions etc. of the mobile sales vehicle 3.

### <Image of Application Field >

FIG. 4 is a diagram showing an image about an application field of the schedule mediation according to the present embodiment. In an area dotted with places (namely, operating places) at which the mobile sales vehicle 3 can conduct business, FIG. 4 is a map illustrating a positional relationship between the customer and the mobile sales vehicle 3.

The application field of FIG. 4 is dotted with operating places A1-A5 where a plurality of mobile sales vehicles 3 can park and the operating places B1-B29 where only one mobile sales vehicle 3 can park.

In addition, the mobile sales vehicle 3 shall park and operate only in these operating places. Moreover, in the operating places A1-A5, a maximum of two sets of mobile sales vehicles 3 can conduct business at the same time of the same day, and only one mobile sales vehicle 3 can conduct business at the same time of the same day at spots B1-B29.

According to the present embodiment, in order to facilitate the understanding of the mode for carrying out the invention, the example shows two mobile sales vehicles 3 carrying the in-vehicle servers 2. Moreover, the operating time is shown as seven hours from 13:00 to 20:00. Moreover, according to the present embodiment, a unit for performing the mediation is one day. However, actually, schedule mediation of a longer period (one month, six months) may be performed.

When performing such schedule mediation, it is desirable to perform schedule mediation which does not largely deviate from a schedule that the in-vehicle server 2 proposes at first (hereafter, called an “initial schedule”).

It is because an entrepreneur providing the mobile shop sales service or an operator of the mobile sales vehicles 3 makes a schedule to maximize the shop KPI from the beginning. The initial schedule reflects the date and time as well as an operating place convenient for the customer who does shopping at the mobile sales vehicle 3, a warehouse for storing the inventory merchandise of the mobile sales vehicle 3, and the operating place and a date and time for conducting business, etc. Therefore, when a schedule is mediated to be the one considerably deviated from the above, it may largely affect the sales profits and expenses on the side of the operator of the mobile sales vehicle 3.

It is because the quantity and freshness of the merchandise that can be loaded into the mobile sales vehicle 3 relate to the needs and degree of satisfaction of the customer, which affects the profit and expenses of the mobile sales vehicle 3.

According to the present embodiment, the initial schedule created in the in-vehicle server 2 is grasped as a “shop KPI.” Also, a “state where the maximization of the shop KPI is achieved” is a state where the schedule mediation in the ground server 1 is completed without changing the initial schedule at all.

In the initial schedules of the two or more mobile sales vehicles 3, when respective operating places and the time of day overlap, one of the operations at the operating places or time of the day in the mobile sales vehicles 3 has to be given up. In such a case, naturally, this means that an operator of each mobile sales vehicle has been unable to attain maximization of the shop KPI.

On the other hand, a “state where the whole KPI is maximized” in the ground server 1 is a state where, with respect to the number of initial schedules proposed from all the in-vehicle servers, mobile shop sales schedules adopted by schedule mediation are all adopted.

Therefore, an object of the present schedule mediation system 100 is to solve two problems of maximizing the KPI of the ground server 1 and, at the same time, maximizing the shop KPI of the in-vehicle server 2.

### <Schedule Mediation Method >

Hereafter, with reference to the drawings, steps of carrying out the schedule mediation method according to the present embodiment will be explained. Various operations corresponding to the schedule mediation method explained below are realized by a program which various units etc. included in the schedule mediation system 100 read to a memory etc., to be executed. Also, the program includes codes for performing various kinds of operations explained below.

FIG. 5 is a sequence diagram of the schedule mediation method according to the present embodiment. In this case, to the in-vehicle server 2 of each mobile sales vehicle 3, the user terminal 4 sends various information about an operating place, a date and time, and merchandise to be purchased being request information to the mobile sales vehicle 3 (s1).

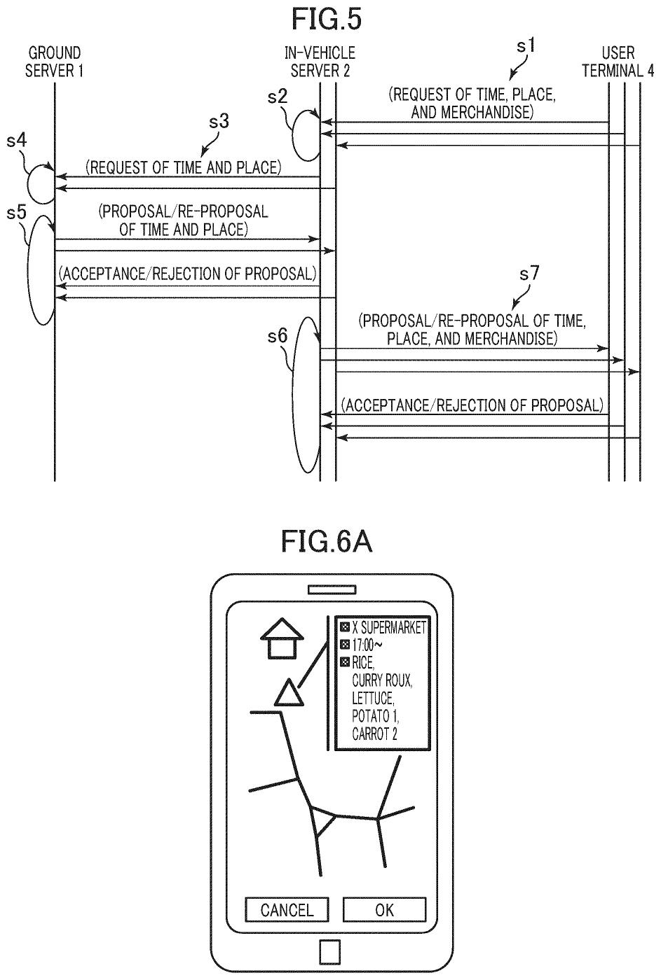

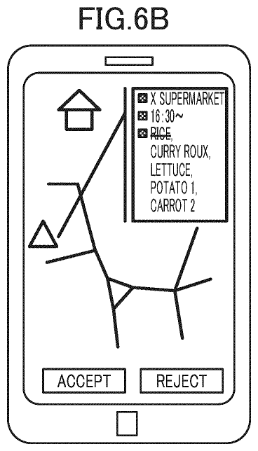

The above information is inputted, through a keyboard, a mouse, etc., by a customer who manipulates the user terminal 4 (refer to a screen 600 of FIG. 6A). FIG. 6A shows a screen on which the customer manipulates the user terminal 4 and performs inputting and sending request information to the above mobile sales vehicle 3.

In addition, the processing of s1 may be performed before the operation of the mobile sales vehicle 3 or during the operation.

Next, the in-vehicle server 2 receives request information from the above user terminal 4. Based on the request information, considering the quantity of merchandise that the mobile sales vehicle can load and a value of discontent of the above customer (referred to as a “user point”), the in-vehicle server 2 creates an initial schedule (s2) and sends it to the ground server 1 within a predetermined time period as a mediation request (s3). The initial schedule created as above may be called a “mobile shop sales schedule” including a sequence of a plurality of operating places and operating time at the operating places.

According to the present embodiment, for the sake of simplicity, the value of the above user point indicates the number of times of the rejection of the initial schedule (specifying operating place, date and time, and merchandise which can be provided) proposed by the in-vehicle server 2 to the request information from the user terminal 4.

The value of the user point is treated as a numerical value indicating the degree of dissatisfaction of the customer to the mobile shop sale. However, when the initial schedule is accepted even once, the degree of discontent shall be reset to zero. Further, the ground server 1 may manages the value of the degree of dissatisfaction for each customer or for each operator of the mobile sales vehicle 3 in the storage unit. Alternatively, each of the user terminals 4 or the in-vehicle server 2 may manage the information concerned. Therefore, when utilizing the value of the degree of dissatisfaction, the in-vehicle server 2 or the ground server 1 being the use subject shall refer to it from a unit performing the above management.

In addition, the user point indicating degree of dissatisfaction can be shown as numerical for walking time exceeding the time that that customer planned for reaching the operating place, a deviation time from the operating time which the customer planned at the beginning, and merchandise inventory/shortage in quantity/frequency that the customer planned initially.

Subsequently, the ground server 1 receives a mediation request from the in-vehicle server 2. When initial schedules compete among the mobile sales vehicles 3, that is, with respect to the parking location, i.e., the operating place in an operational field, when the mediation requests from the mobile sales vehicles 3 exceeding the upper limit number of stoppable vehicles overlap in the same time zone, in order to settle the competing situation, the ground server 1 performs mediation of the initial schedules so that the operations of the mobile shop sales in the operation place during the same time zone do not overlap, creates a mobile shop sales schedule (after-correction schedule) (s4), and proposes it to the in-vehicle server 2 (s5).

As a specific example, the ground server 1 gives priority to the mediation request with more shop points which the in-vehicle server 2 owns, and re-proposes the substitute mobile shop sales schedule to the mediation request with fewer shop points. The in-vehicle server 2 which received the substitute re-proposal from the ground server 1 may accept the proposal, or may propose another initial schedule again.

Incidentally, a shop point is value in which 1 point is added when the mediation request of the mobile sales vehicle 3 concerned loses the competing mediation with other mobile sales vehicles 3 in the ground server 1 and the correction proposal of the initial schedule is done. However, it is reset by zero when the competing mediation is won at least once (i.e., when the initial schedule passes as requested).

When all the in-vehicle servers 2 consented to the above re-proposal, mediation of the initial schedule is completed. The shop point of the in-vehicle server 2 which won the competition is reset by zero, and one point is added to the shop points of the in-vehicle server 2 lost in the competition.

The above shop point is dealt as a numerical value which indicates the dissatisfaction degree of the in-vehicle server 2 of the mobile sales vehicle 3 to the ground server 1. The shop point can also be used as a numerical value indicating time for a shop to exceed the business hours being planned at the beginning, the time of the gap from the operating time of day which the shop planned at the beginning, and the distance of gap from the operating place which the customer expected at the beginning.

Next, based on the mobile shop sales schedule agreed according to a proposal/re-proposal of the ground server 1, the in-vehicle server 2 corrects the initial request information of the user terminal 4 (s6), and distributes and proposes this to the user terminal 4 (s7).

On the other hand, with the user terminal 4, the customer can check the above proposal, and can accept/refuse it. FIG. 6B shows a display screen of the information proposed through the in-vehicle server 2 to the request information by the customer (from the ground server 1). This example shows a state where the merchandise “rice” specified by the request information cannot be provided due to an inventory condition of the mobile sales vehicle 3, and is canceled.

When the rejection sent from the user terminal 4 to an above proposal as described, the in-vehicle server 2 records the number of times of the rejection as a user point. The in-vehicle server 2 can treat the customer with a large value of this user point preferentially by the processing on and after next time.

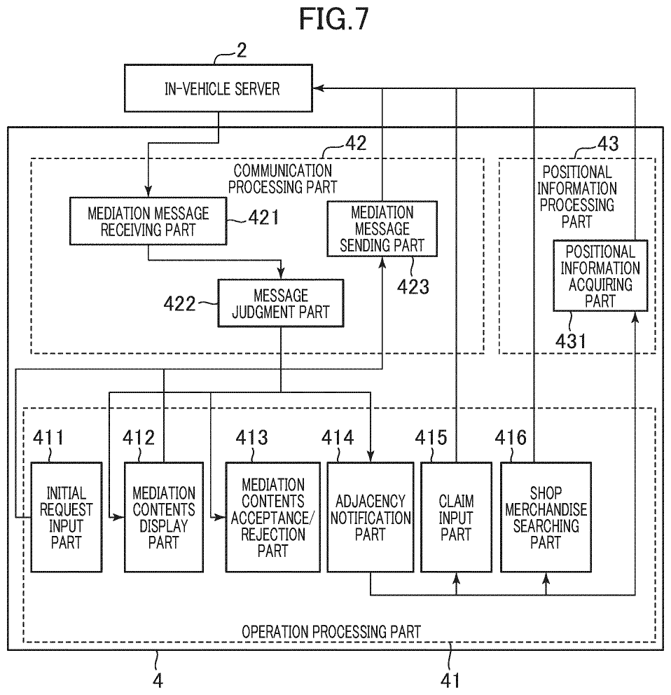

Hereafter, together with description of the function of each unit, the details of the schedule mediation method will be explained. FIG. 7 is a diagram showing a software configuration stored in the memory 102 of the user terminal 4. Arrows in FIG. 7 show the relationship in which a software module is called or is referred to, and shall be grasped also as an algorithm of a program.

These programs are deployed in the memory 102 of FIG. 2 and are executed by CPU 101. Storage information required for each module of the communication processing part 22 and the online processing part 23 is stored in the memory 102. However, storage information required for each module of the offline processing part 24 is recorded not only in the memory 102 but also on HDD 104.

First, in the initial request input unit 411 of the operation processing part 41, a customer specifies the in-vehicle server 2 (of the mobile sales vehicle 3 nearby or out of the list items held beforehand). Then, with respect to the mobile sales vehicle 3 carrying the in-vehicle server 2, the customer inputs the desired operating place and the date and time for the vehicle concerned to come, and merchandise to purchase (FIG. 6A shows its screen).

The information inputted here is transmitted to the in-vehicle server 2 through a mediation message sending part 423 of the communication processing part 42.

Moreover, the mediation message sent from the in-vehicle server 2 (example: at the result of mediation in the ground server 1, the message notifying the necessary correction contents of the initial schedule, or the message notifying that the initial schedule has been accepted as it is) is received by the mediation message receiving part 421 of the communication processing part 42 and, then, transmitted to the message judgment part 422.

According to the contents, the message judgment part 422 transmits the mediation message concerned to a mediation contents display part 412, a mediation contents acceptance/rejection part 413, and an adjacency notification part 414 of the operation processing part 41.

On the mediation contents display part 412, with respect to the initial schedule corresponding to the request information of the customer, a mediation message being a correction proposal from the in-vehicle server 2 is shown. However, the message may not be a correction proposal but the one indicating that there is no correction (when the mediation competition is won).

Concerning the above correction proposal, the customer manipulates the mediation contents acceptance/rejection part 413, and shows the acceptance/rejection (FIG. 6B shows its screen). In this regard, the correction proposal includes a case where the operating place or a date and time are changed from (an initial schedule according to) the request information or a case where part of desired merchandise is out of stock and not available.

Moreover, the adjacency notification part 414 acquires the positional information of the mobile sales vehicle 3 from the mobile sales vehicle 3 and compares it with the own positional information, and judges whether the mobile sales vehicle 3 carrying the in-vehicle server 2 is within a predetermined distance from the present user terminal 4. When it is judged that the mobile sales vehicle is within the distance, the adjacency notification part 414 notifies the adjacency information. This notification may be done in a popup etc. on the display screen of the user terminal 4.

In addition, the mobile sales vehicle 3 detecting the adjacency is the one which issues the mediation message received by the user terminal 4, and is the mobile sales vehicle 3 which corresponds to the mediation case accepted by the customer.

Moreover, with respect to the above accepted mediation case, in the distance the user terminal 4 is judged to be close to the in-vehicle server 2, the claim input part 415 receives a claim message concerning the mobile sales vehicle 3 from the customer and sends it to the in-vehicle server 2. The claim message is a message relating to dissatisfaction which the customer concerned holds about the mobile sales vehicle 3.

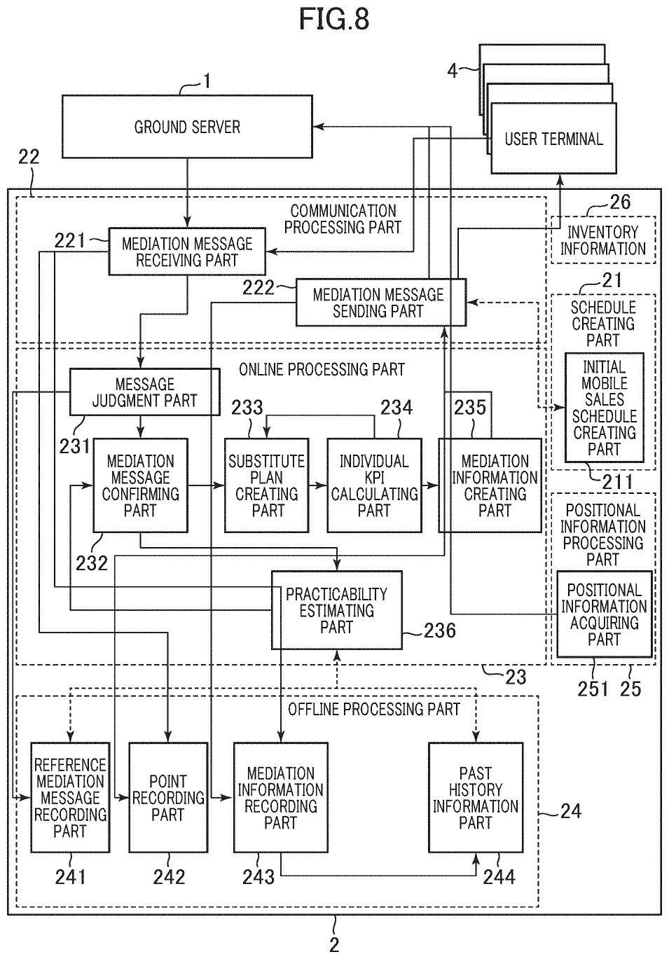

Moreover, with respect to the accepted mediation case, in the distance that the user terminal 4 judges to be close to the in-vehicle server 2, a shop merchandise search part 416 searches the merchandise loaded in the mobile sales vehicle 3 of the in-vehicle server 2. The target to be searched is inventory information (inventory information 26 in FIG. 8) held by the in-vehicle server 2.

Moreover, after the acceptance of the mediation, the positional information acquiring part 431 of the positional information processing part 43 acquires own positional information with a proper positional information acquiring means, such as a GPS (Global Positioning System) unit which the user terminal 4 has, and keeps transmitting it to the in-vehicle server 2.

FIG. 8 is a diagram showing a software configuration stored in the memory 102 of the in-vehicle server 2. Arrows in FIG. 8 show the relationship in which a software module is called or is referred to, and shall be grasped also as an algorithm of a program.

These programs are deployed in the memory 102 of FIG. 2 and are executed by CPU 101. Storage information required for each module of the communication processing part 22 and the online processing part 23 is stored in the memory 102. However, storage information required for each module of the offline processing part 24 is recorded not only on the memory 102 but also on HDD 104.

The positional information acquiring part 251 of the positional information processing part 25 acquires the positional information of its own with a proper positional information acquiring means, such as a GPS (Global Positioning System) unit, and continues transmitting this to the ground server 1.

Moreover, the initial schedule creating part 211 of the schedule creating part 21 creates an initial schedule. The creation of the initial schedule may be any of the cases where the operator who uses the display of FIG. 2, a keyboard, and a mouse creates using a predetermined tool, and the case of automatically creating based on the user request to be described later.

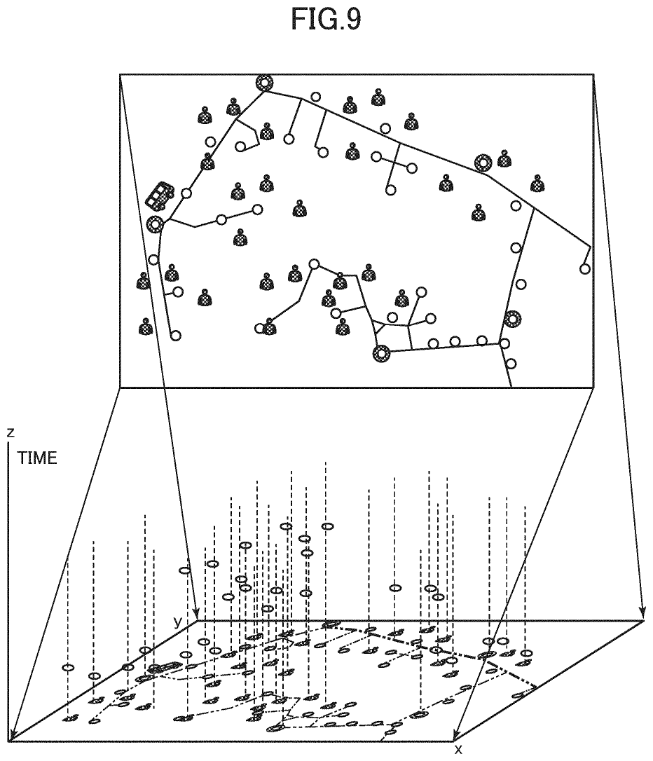

Here, FIG. 9 shows the specific example of the request information transmitted to the in-vehicle server 2 from each customer's user terminal 4. Here, it is the three-dimension image in which each of the request information is shown in the viewpoint of operating area and date-and-time. In this case, z axis shows the time of the orientation of the future, and x axis and y axis show the map plane of an operational field. Positions indicated by circles on the three-dimensional space show the shop position and the business hours (purchase time) that the customer requests on an operational field.

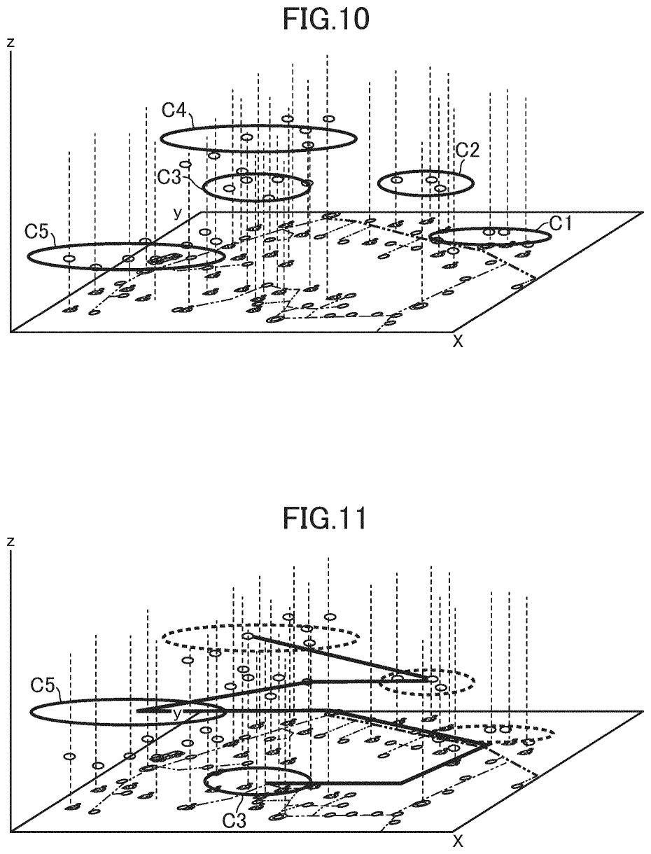

Moreover, FIG. 10 is a diagram which has grasped the above request information as the three-dimensional points of an operating area (latitude and longitude) and store hours, and clusters it into C1-C5 clusters. It was clustered into five clusters because it is supposes that the mobile sales vehicle 3 conducts business at five places. However, any number can be applicable. As this clustering, K average method may be used being an algorithm of non-hierarchical type clustering, for example.

FIG. 11 shows an example where cluster C-3 and cluster C-5 are moved from a state in FIG. 10, and creates an initial schedule is created with a place around the hub as a position where the mobile sales vehicle 3 parks and conducts business.

Clusters C-3 and C-5 are moved to reduce user points as a whole because the sum of the user points of the users included in the clusters C-3 and C-5 is smaller than the sum of the user points included in other clusters, and because it is judged that a transit time can be fully secured in the case of the initial schedule.

Now, returning to an illustration of FIG. 8, the initial schedule created as above is transmitted to the mediation message sending part 222 of the communication processing part 22.

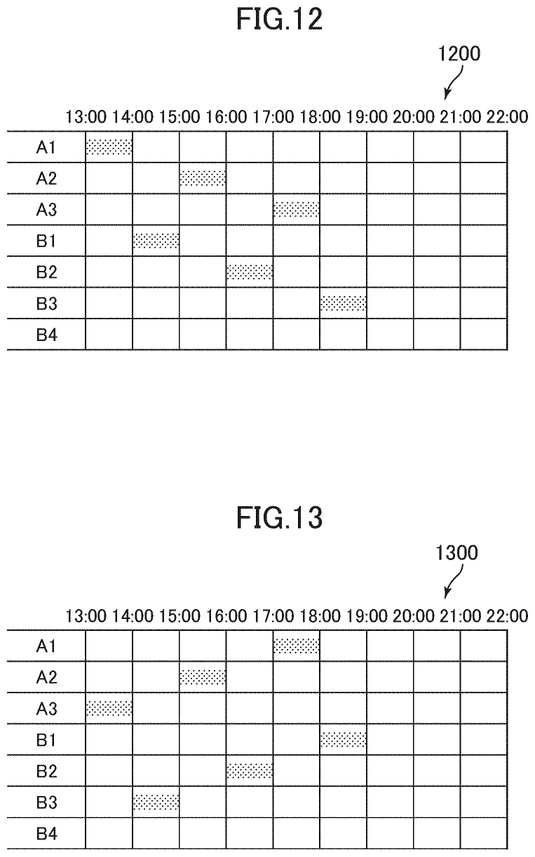

FIG. 12 is a diagram showing an initial schedule 1200 of a mobile sales vehicle 3-1 carrying an in-vehicle server 2-1, and FIG. 13 is a diagram showing an initial schedule 1300 of a mobile sales vehicle 3-2 carrying an in-vehicle server 2-2.

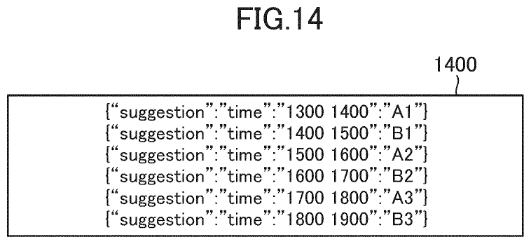

Moreover, FIG. 14 is a diagram showing an example of a mediation message relating to an initial schedule generated in the in-vehicle server 2. This mediation message shows information about business hours of the mobile sales vehicle 3 and an operating place which were specified by the initial schedule. The first line is a description initially proposing the operation at a position A1 the time zone from 13:00 to 14:00. The creation of similar mediation message is carried out in each in-vehicle server 2 as well.

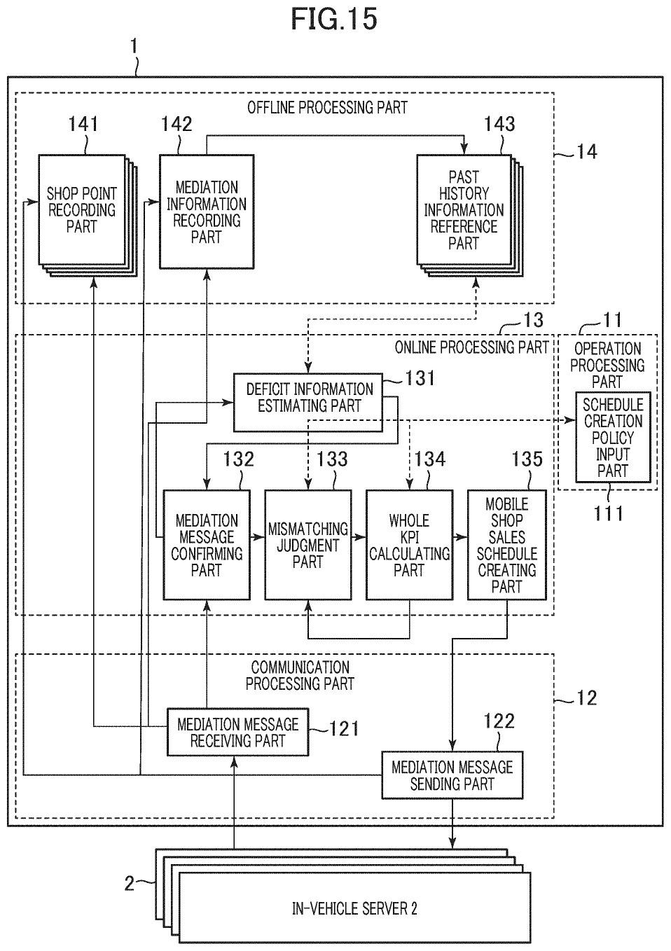

FIG. 15 is a diagram showing a software configuration deployed in the memory 102 of the ground server 1. Arrows in FIG. 15 show the relationship in which a software module is called or is referred to, and shall be grasped as an algorithm of the program.

These programs are deployed in the memory 102 of FIG. 2, and are executed by CPU 101. Storage information required for each module of the communication processing part 12 and the online processing part 13 is stored in the memory 102. However, storage information required for each module of the offline processing part 14 is recorded not only in the memory 102 but also on HDD 104.

The mediation message (proposed mediation message) of the initial schedule created in the in-vehicle server 2 is received through a network 5 in the mediation message receiving part 121 of the communication processing part 12 of the ground server 1.

Further, the mediation message is transmitted to the mediation message confirming part 132 of the online processing part 13, and its style is checked, such as a format and, when there is a defect in the format, it is corrected according to a predetermined rule.

The mediation message is further sent to a deficit information estimating part 131. When there is no deficit information, it is again returned to the mediation message confirming part 132 as it is. The deficit information means a mediation message without a specification of a date and time, for example, although there is a specification of an operating place. In such a case, the deficit information estimating part 131 specifies time at which there is no competing situation with other schedules, appoints the time concerned, and compensates the deficit information.

When the mediation messages of the initial schedules from the in-vehicle server 2-1 and the in-vehicle server 2-2 are ready, the mediation message confirming part 132 of the online processing part 13 transmits them to the mismatching judgment part 133. The mismatching judgment part 133 checks whether or not there is a conflict (hereafter, called a “competing situation”) of the initial schedules.

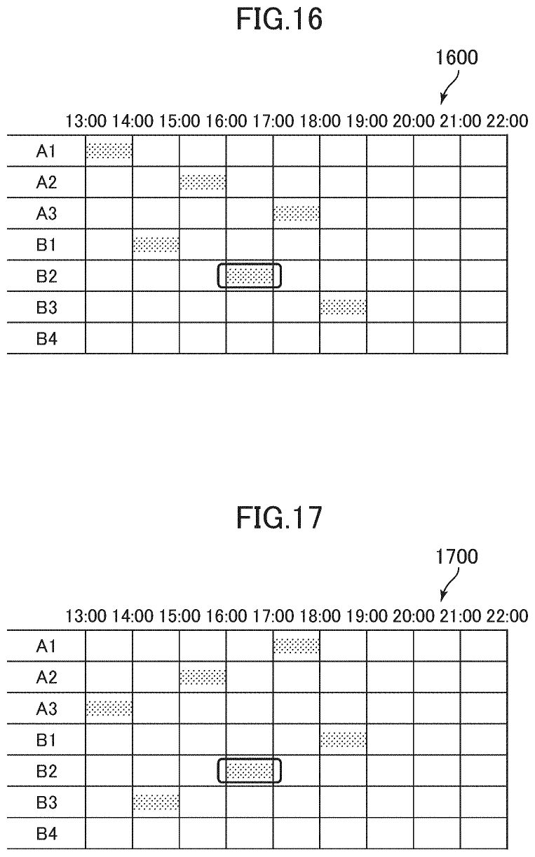

FIGS. 16 and 17 show a competing occurrence state between the initial schedules 1600 and 1700 of the in-vehicle server 2-1 and the in-vehicle server 2-2, respectively. When referring to the initial schedules 1600 and 1700 of the in-vehicle server 2-1 and the in-vehicle server 2-2, respectively, it is seen that there is a conflict of time with respect to an operating place B-2. On the other hand, it seems that there is also a conflict of time with respect to an operating place A2. However, a conflict does not occur, because a maximum of two mobile sales vehicles 3 can park at the operating place A2.

Returning to the explanation of FIG. 15, the initial schedule described above enters a mobile shop sales schedule creating part 135 of the online processing part 13 and a mobile shop sales schedule is created. As a creation policy, a candidate for priority can be judged based on the store point which the in-vehicle server 2 has. In the present embodiment, the store having the larger number of store points is prioritized to solve a competing situation.

According to the mobile shop sales schedule creation policy of the mobile shop sales schedule creation policy input part 111 of the operation processing part 11, the mismatching judgment part 133 in the online processing part 13 of the ground server 1 creates a new mobile shop sales schedule which avoids a schedule conflict, and gives it to the whole KPI arithmetic part 134.

The whole KPI arithmetic part 134 creates a newer mobile shop sales schedule on the basis of the new mobile shop sales schedule.

When a conflict occurs in a mobile shop sales schedule, the whole KPI arithmetic part 134 returns the mobile shop sales schedule to the mismatching judgment part 133. While the mismatching judgment part 133 and the whole KPI arithmetic part 134 repeat the above processing, they function to complete the mobile shop sales schedule.

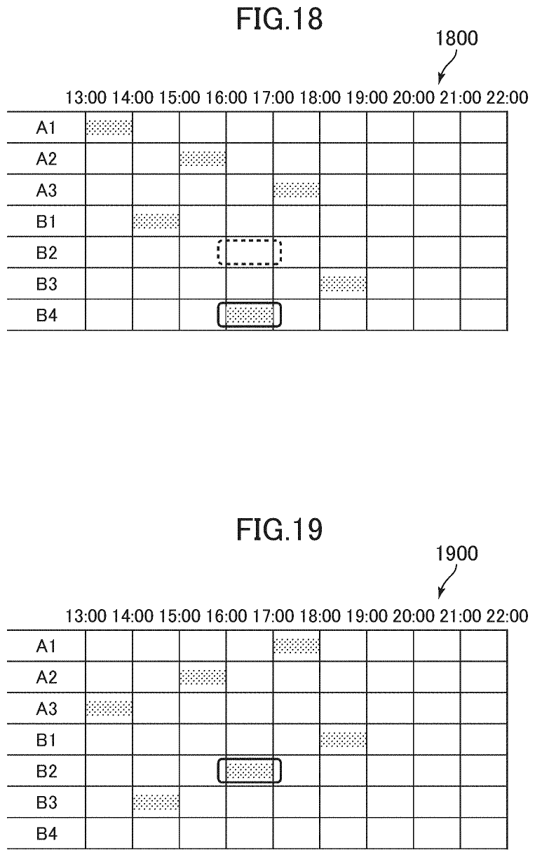

FIG. 18 and FIG. 19 are diagrams showing examples of mobile shop sales schedules which were corrected and created by the ground server 1 and in which the conflict about the initial schedules 1600 and 1700 are mediated. In this example, by moving operating place B2 of the time 16:00-17:00 in the initial schedule 1600 to an operating place B4, as shown in FIG. 18, a competing situation with the initial schedule 1700 is mediated, the schedule 1800 is created after correction.

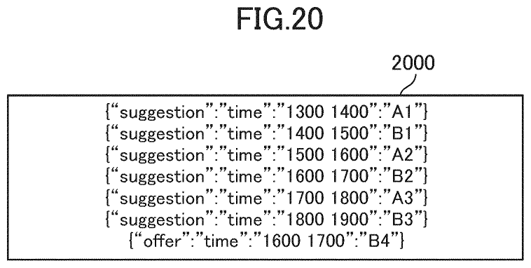

FIG. 20 is a diagram showing the content of the counter-proposal message 2000 of FIG. 20 from the ground server 1 to the mediation message illustrated in FIG. 14.

The counter-proposal message 2000 is sent to the mediation message receiving part 221 of the communication processing part 22 of FIG. 8 in the in-vehicle server 2.

In addition, a mediation information recording part 243 of the offline processing part 24 records a mediation message received in the mediation message receiving part 221 of the communication processing part 22 of FIG. 8 and the mediation message sent from the mediation message sending part 222. This record is stored in the past history information part 244 of the offline processing part 24.

The mediation message from the ground server 1 is received in the mediation message receiving part 221 in the communication processing part 22 of the in-vehicle server 2 of FIG. 8 and, then, transmitted to the mediation message confirming part 232 of the online processing part 23. Furthermore, this mediation message is sent to a practicability estimating part 236 and is compared with the initial schedule created in the initial mobile shop sales schedule creating part 211 of the schedule creating part 21.

Further, the mediation message received in the mediation message receiving part 221 of the communication processing part 22 of FIG. 8 and the mediation message sent from the mediation message sending part 222 are sent to the mediation information recording part 243 of the offline processing part 24 and is recorded on HDD 104 of FIG. 2 in the past history information part 244.

Moreover, the past history information part 244 of the offline processing part 24 and the reference mediation message recording part 241 are referred to from the practicability estimating part 236 of the online processing part 23, and are used as reference information when creating a mediation message.

Next, FIG. 21 shows an ER diagram of data handled in the schedule mediation system 100 of the present embodiment. Those described as “history” below will be stored on HDDs 104 of the ground server 1 and the in-vehicle server 2, respectively. Other data are used in the memory 102.

The ground server 1 can hold data 21-01, data 21-02, data 21-03, data 21-04, data 21-05, data 21-06, data 21-07, data 21-08, data 21-09, data 21-10, and data 21-12.

Of the data described above, data 21-01 is the data related to an administrator of the ground server 1.

Moreover, data 21-02 is the data related to an operating place under the control of the ground server 1, namely, data related to a parking position of a mobile sales vehicle 3.

Moreover, data 21-03 is the data related to the mobile sales vehicle 3 under the control of the ground server 1.

Moreover, data 21-04 is the data related to the operating places which are currently available.

Moreover, data 21-05 is the data related to the sales schedule of the mobile sales vehicle 3.

Moreover, data 21-06 is the data related to the sales history of the mobile sales vehicle 3.

Moreover, data 21-07 is the data related to the sales status of the mobile sales vehicle 3.

Moreover, data 21-08 is the data related to a supply/shipment status of the mobile sales vehicle 3.

Moreover, data 21-09 is the data related to a history of a supply/shipment status of a mobile sales vehicle.

Moreover, data 21-10 is the data related to the operating places of the mobile sales vehicle 3.

Moreover, data 21-11 is the data related to the positional information on a map.

On the other hand, the in-vehicle server 2 holds the data 21-11 about customers. Moreover, the in-vehicle server 2 can hold data 21-04 of operating places which is related to a mobile sales vehicle 3 carrying the in-vehicle server 2 itself and which is in a currently available state, data 21-05 about a sales schedule of the mobile sales vehicle 3 concerned, the data 21-07 of the sales history of the mobile sales vehicle 3, data 21-06 of the operating standing of the mobile sales vehicle 3, data 21-08 of a supply/shipment status of the mobile sales vehicle 3, data 21-09 of the history of a supply/shipment status of the mobile sales vehicle 3, and data 21-10 of the operating position of the mobile sales vehicle 3.

In addition, data from data 21-13 to data 21-18 are the ones which manage the positional information of the place a high-order server controls. An example of data of an open street map (URL: https://www.openstreetmap.org/[online], retrieved on Dec. 17, 2019 retrieve]) is shown here.

The title of the data base corresponds to a description on its website (URL: https://wiki.openstreetmap.org/wiki/Elements [online], retrieved on Dec. 17, 2019).

Although the best mode etc. for carrying out the present invention has been specifically described as above, the present invention is not limited to this but can be variously modified within the scope not deviating from the spirit thereof.

According to the present embodiment described above, profits of respective stakeholders related to business by the mobile shop vehicles can be adjusted efficiently and to create preferable schedules for mobile shops can be created.

The followings are clarified at least by description of this written description. That is, the schedule mediation system may further include a user terminal having a communication unit and an arithmetic unit. The communication unit performs communication with the in-vehicle server. The arithmetic unit performs, with respect to the mobile sales, processing to acquire information about the merchandise for which the customer asks and purchase condition through the input unit, and sends request information including the merchandise and purchase conditions to the in-vehicle server through the communication unit, processing to receive the corrected request information from the in-vehicle server as a counter-proposal and display the counter-proposal on an output unit, and processing to accept the customer's intention of acceptance/rejection to the counter-proposal with the input unit and give the acceptance/rejection information to the in-vehicle server.

According to this, also about the customer of the mobile sales vehicle who is a stakeholder, his or her intention is respected more and it becomes possible to make it reflected in schedule mediation. Further, profits of respective stakeholders related to business by the mobile shop vehicles can be efficiently adjusted and more preferable schedules for mobile shops can be created.

Moreover, in the schedule mediation system of the present embodiment, the schedule mediation server may be the one which manages, with respect to each stakeholder who is one of an operator of the mobile sales vehicle, the customer, and a person who provides an operating place to the mobile sales vehicle, dissatisfaction information collected from the stakeholders in a series of processing accompanying the request information and, in correcting the initial schedule, judges the dissatisfaction value by performing numerical conversion of the dissatisfaction information with a predetermined rule. The schedule mediation server further performs, under the restriction where the dissatisfaction value of the stakeholder stays within a particular range during a predetermined period, correction of the initial schedule and creates the after-correction schedule.

Accordingly, not only acceptance or rejection of a proposed schedule determines the adoption or rejection of the proposal, by directivity to consider dissatisfied feelings accumulated in the person concerned with the background of the acceptance and rejection, schedule correction and the proposal become possible. Further, profits of respective stakeholders related to business by the mobile shop vehicles can be adjusted efficiently and more preferable schedules for mobile shops can be created.

Moreover, in the schedule mediation system of the present embodiment, the in-vehicle server may be the one which refers to, when creating the initial schedule, the dissatisfaction information of each customer from the schedule mediation server and, under the restriction where the customer having more number of times of rejection to the counter-proposal shown by the dissatisfaction information tends to accept the request information, and creates the initial schedule, and the schedule mediation server refers to, when correcting the initial schedule, the dissatisfaction information of the operator of each mobile sales vehicle from the storage unit and, under the restriction where an operator having more number of times of rejection to the corrected schedule shown by the dissatisfaction information tends to accept the initial schedule, performs correction of the initial schedule.

Accordingly, not only acceptance or rejection of the schedule proposal determines the adoption or rejection of the proposal, by directivity to consider dissatisfied feelings accumulated in the customers or the operators of the mobile sales vehicles with the background of the acceptance and rejection and to solve it, schedule correction and the proposal become possible. Further, profits of respective stakeholders related to business by mobile shop vehicles can be adjusted efficiently, and more preferable schedules for mobile shops can be created.

Moreover, in the schedule mediation system of the present embodiment, the in-vehicle server may be the one which performs, when creating the initial schedule, based on a purchase place and purchase date and time for which each of the customers asks indicated by the request information of each of the customers, clustering the request information, calculating the total value of the number of times of rejections by the customers included in each cluster, and creates the initial schedule under the restriction of accepting the request information according to the size of the total value.

As a result, according to the dissatisfaction size of the customer who desires to purchase in the area concerned, the significance of the cluster concerned, namely, the priority level of schedule control can be controlled. Further, profits of respective stakeholders related to business by a mobile shop vehicle can be adjusted efficiently, and more preferable schedules for the mobile shops can be created.

Moreover, in the schedule mediation system of the present embodiment, the in-vehicle server may be the one which creates, when creating the initial schedule, the initial schedule under the restriction where an operating place of the mobile sales vehicle carrying the in-vehicle server belongs to the purchase place and the purchase date and time included in the cluster, and the mobile sales vehicle performs business while moving between the clusters within a predetermined time period.

As a result, for example, it becomes possible to properly create a schedule which includes operating places that the mobile vehicle can visit in a day (time-wise and cost-wise). Further, profits of respective stakeholders related to business by mobile shop vehicles can be adjusted efficiently, and more preferable schedules for the mobile shops can be created.

What is claimed is:

1. A schedule mediation system, comprising:
an in-vehicle server of a mobile sales vehicle; and
a schedule mediation server,
the in-vehicle server of a mobile sales vehicle including:
a storage unit configured to hold at least inventory information showing a merchandise stock on board; and
an arithmetic unit configured to execute: processing of receiving, from a user terminal of a customer, request information containing various information about merchandise and purchase conditions for which the customer asks, checking the inventory of the merchandise based on the inventory information and, based on a purchase area and a purchase date and time shown by the purchase conditions, creating an initial schedule for a mobile sales; processing of sending a mediation request including the initial schedule to a schedule mediation server and receiving, from the server, an after-correction schedule corrected according to a result of mediation between mediation requests in the server; processing of judging acceptance/rejection by a predetermined rule with respect to the after-correction schedule, and giving a result of judgment to the server; and processing of correcting the request information according to the after-correction schedule accepted in the judgment and sending the corrected request information to the user terminal; and
the schedule mediation server including:
a storage unit configured to hold the mediation request received from an in-vehicle server of each mobile sales vehicle; and
an arithmetic unit configured to execute: processing of mediation to settle a competing situation between the initial schedules indicated by the held mediation request according to the competing situation concerning the purchase place and the purchase date and time and correcting the initial schedule based a result of the mediation; processing of sending an after-correction schedule acquired in the correction to the in-vehicle server; and processing of receiving, from the in-vehicle server, a judgment result of acceptance/rejection at the in-vehicle server with respect to the after-correction schedule and, when the judgment result is a rejection, acquiring a new after-correction schedule made by another correction for settling the competing situation and re-proposing the new after-correction schedule to the in-vehicle server.

2. A schedule mediation system according to claim 1 further comprising a user terminal,
the user terminal including:
a communication unit configured to perform communication with the in-vehicle server; and
an arithmetic unit configured to perform, with respect to the mobile sales, processing to acquire information about merchandise and purchase conditions for which the customer asks through the input unit, and to send request information including the merchandise and purchase conditions to the in-vehicle server through the communication unit, processing to receive the corrected request information from the in-vehicle server as a counter-proposal and displays the counter-proposal on an output unit, and processing to accept customer's acceptance/rejection to the counter-proposal with the input unit and gives the acceptance/rejection information to the in-vehicle server.

3. A schedule mediation system according to claim 1,
wherein the schedule mediation server manages, with respect to each stakeholder who is one of an operator of the mobile sales vehicle, the customer, and a person who provides an operating place to the mobile sales vehicle, dissatisfaction information collected from the stakeholders in a series of processing accompanying the request information, and
wherein, in correcting the initial schedule, the schedule mediation server judges the dissatisfaction value by numerically converting the discontent information based on the predetermined rule and performs, under the restriction where the dissatisfaction value of the stakeholder stays within a particular range during a predetermined period, correction of the initial schedule and creates the after-correction schedule.

4. A schedule mediation system according to claim 3,
wherein, when creating the initial schedule, the in-vehicle server refers to the dissatisfaction information of each customer from the server for schedule mediation and, under the restriction where the customer having larger number of times of rejections to the counter-proposal shown by the dissatisfaction information tends to accept the request information, and creates the initial schedule, and
wherein, when correcting the initial schedule, the mediation server refers to the dissatisfaction information of the operator of each mobile sales vehicle with the storage unit, and performs correction of the initial schedule under the restriction where an operator having larger number of times of rejection to the corrected schedule shown by the dissatisfaction information tends to accept the initial schedule.

5. A schedule mediation system according to claim 4,
wherein when creating the initial schedule, the in-vehicle server performs clustering of the request information based on information about a purchase place and purchase date and time for which each of the customer asks indicated by the request information of each of the customers, calculating the total value of the number of times of rejections by the customer included in each cluster, and creates the initial schedule under the restriction of accepting the request information according to the size of the total value.

6. The schedule mediation system according to claim 5,
wherein, when creating the initial schedule, the in-vehicle server creates the initial schedule under the restriction where an operating place of the mobile sales vehicle carrying the in-vehicle server belongs to the purchase place and the purchase date and time included in the cluster, and the mobile sales vehicle operates while moving between the clusters within a predetermined time period.

7. A schedule mediation method, comprising:
by an in-vehicle server of a mobile sales vehicle, holding at least inventory information showing a merchandise stock on board,
by the in-vehicle server of the mobile sales vehicle, executing processing of receiving, from a user terminal of a customer, request information containing various information about merchandise and purchase conditions for which the customer asks, checking the inventory of the merchandise based on the inventory information and, based on a purchase place and a purchase date and time shown by the purchase conditions, creating an initial schedule for a mobile sales, processing of sending a mediation request including the initial schedule to a schedule mediation server and receiving, from the server, an after-correction schedule corrected according to a result of mediation between mediation requests in the server, processing of judging acceptance/rejection according to a predetermined rule with respect to the after-correction schedule and giving a result of the judgment to the server, and processing of correcting the request information according to the after-correction schedule accepted in the judgment and sending the corrected request information to the user terminal, and
by a schedule mediation server, holding the mediation request received from an in-vehicle server of each mobile sales vehicle, and
by the schedule mediation server, executing processing of mediation to settle a competing situation between initial schedules according to the competing situation about the purchase place and the purchase date and time between the initial schedules shown by the held mediation request, and correcting the initial schedule based on a result of the mediation, processing of sending an after-correction schedule acquired in the correction to the in-vehicle server, and processing of receiving a judgment result of acceptance/rejection in the in-vehicle server for the after-correction schedule from the in-vehicle server and, when the judgment result is a rejection, acquiring a new after-correction schedule from another correction for settling the competing situation and re-proposing the new after-correction schedule to the in-vehicle server.
